(19) United States
(12) Patent Application Publication
(10) Pub. No.: US 2018/0329794 A1
(43) Pub. Date: Nov. 15, 2018

(54) VISUALIZATION OF MAPPING BETWEEN NETWORK OVERLAY AND UNDERLAY

(71) Applicant: Cisco Technology, Inc., San Jose, CA (US)

(72) Inventors: Alberto Gonzalez Prieto, Santa Clara, CA (US); Thangavelu Arumugam, San Jose, CA (US); Sachin Saxena, Fremont, CA (US); Vijay Arumugam Kannan, Milpitas, CA (US); Srinivas Kodali, Santa Clara, CA (US)

(21) Appl. No.: 15/590,061

(22) Filed: May 9, 2017

(51) Int. Cl. G06F 11/32; H04L 12/24; G06F 3/0481; G06F 3/0484

(52) U.S. Cl. CPC G06F 11/328; H04L 41/12; G06F 3/0484; G06F 3/0481; G06F 3/04817; H04L 41/22

(57) ABSTRACT

The subject disclosure describes solutions for graphically displaying hierarchical relationships between a network underlay and a network overlay. In some aspects, a method of the technology includes steps for aggregating associations between each of a plurality of physical network devices and one or more virtual network entities, displaying two or more pivot options that graphically represent the physical network devices and/or the virtual network entities, and receiving a pivot selection indicating at least one physical network device or virtual network entity for which hierarchy information is requested by a user. In some aspects, the method can further include steps for graphically displaying one or more layers of a network hierarchy based on the pivot selection. Systems and machine-readable media are also provided.

### TECHNICAL FIELD

The disclosed technology relates to methods and systems for graphically displaying layers of a network hierarchy. In particular, aspects of the technology relate to the display of multiple network layers, including the concurrent display of network overlay and underlay hierarchies.

### BACKGROUND

The utilization of network function virtualization (NFV) and software defined network (SDN) technologies allows the decoupling of network functions from underlying hardware so they can run as software images or logical modules on commercial off-the-shelf and purpose-built hardware. Network virtualization makes it possible to use off-the-rack technologies (e.g., computers and storage media) to virtualize network functions. One objective of NFV deployments is to reduce dependence on dedicated physical devices by allocating and using the physical and virtual resources only when needed.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only example aspects of the disclosure and are not therefore to be considered to be limiting of its scope, the principles herein are described and explained with additional specificity and detail through the use of the accompanying drawings in which:

FIG. 1 illustrates an example virtual network environment that may be used to implement some aspects of the subject technology.

FIG. 2 illustrates steps of an example process for graphically representing various layers of a network hierarchy, according to some aspects of the technology.

FIGS. 3A-3D illustrate examples of various graphical displays that can be used to visualize layers of a network overlay hierarchy.

FIGS. 3E-3G illustrate examples of various graphical displays, including implementation of various display option parameters, that can be used to visualize layers of an overlay hierarchy.

FIGS. 4A-4C illustrate examples of various graphical displays that can be used to visualize layers of an underlay hierarchy, according to some aspects of the technology.

FIG. 5 illustrates an example of a network device.

FIGS. 6A and 6B illustrate example system embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview:

Additional features and advantages of the disclosure are set forth in the description that follows, and in part are obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

A method of the technology includes steps for aggregating associations between various physical devices and virtual network entities, displaying two or more pivot options that graphically represent the physical network devices and/or the virtual network entities, and receiving a pivot selection indicating at least one physical network device or virtual network entity for which hierarchy information is requested by a user. In some aspects, the method can further include steps for graphically displaying one or more layers of a network hierarchy based on the pivot selection. In some embodiments, concurrent displays of network overlay and underlay hierarchies are provided.

As used herein, a pivot option graphically indicates a “pivot” or “pivot point” in the associated network providing an abstraction representing either a single network entity, or a set of network entities. As discussed in further detail below, the network entity (or entities) corresponding with the pivot can exist in either the network overlay or underlay.

### DESCRIPTION

The proliferation of network virtualization technologies has made it increasingly difficult to graphically depict various layers of a physical and virtual network hierarchy. This difficulty is further compounded by the logical division of network resources among multiple “tenants,” or groups of users or other entities that share common access and specific privileges to network resources and applications.

Aspects of the subject disclosure address the foregoing need by providing methods for graphically visualizing a network hierarchy, including overlay and underlay portions of network infrastructure. As discussed in further detail below, visualizations can be provided from the vantage point of a selected network element (e.g., a “pivot” or “pivot selection”) that corresponds with either a physical or virtual network device or entity. By way of example, a selected pivot can be any unitary device (physical or virtual), and/or logical association of devices, such as a virtual machine, a router, or a subnet, etc.

In some aspects, graphical representations of “context” are also provided, for example, that represent a location of a given “pivot” or “pivot point” within a network hierarchy tree.

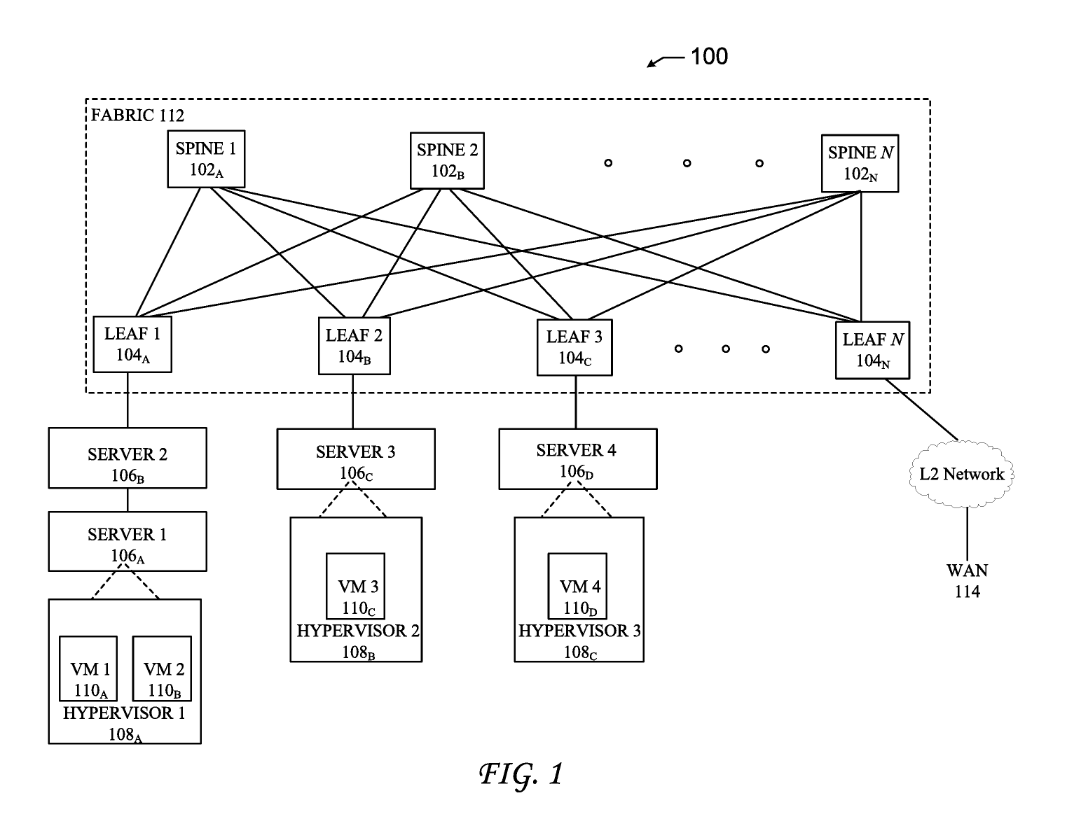

FIG. 1 illustrates a diagram of an example virtual network environment 100, for which network visualizations of the technology can be generated. Fabric 112 can represent the underlay (i.e., physical network) of environment 100. Fabric 112 can include spine routers 1-N (102_{A-N}) (collectively “102”) and leaf routers 1-N (104_{A-N}) (collectively “104”). Leaf routers 104 can reside at the edge of fabric 112, and can represent the physical network edges. Leaf routers 104 can be, for example, top-of-rack (“ToR”) switches, aggregation switches, gateways, ingress and/or egress switches, provider edge devices, and/or any other type of routing or switching device.

Leaf routers 104 can be responsible for routing and/or bridging tenant or endpoint packets and applying network policies. Spine routers 102 can perform switching and routing within fabric 112. Thus, network connectivity in fabric 112 can flow from spine routers 102 to leaf routers 104, and vice versa.

Leaf routers 104 can provide servers 1-4 (106_{A-D}) (collectively “106”), hypervisors 1-4 (108_{A}-108_{D}) (collectively “108”), virtual machines (VMs) 1-4 (110_{A}-110_{D}) (collectively “110”), collectors 118, engines 120, and the Layer 2 (L2) network access to fabric 112. For example, leaf routers 104 can encapsulate and decapsulate packets to and from servers 106 in order to enable communications throughout environment 100. Leaf routers 104 can also connect other network-capable device(s) or network(s), such as a firewall, a database, a server, etc., to the fabric 112. Leaf routers 104 can also provide any other servers, resources, endpoints, external networks, VMs, services, tenants, or workloads with access to fabric 112.

VMs 110 can be virtual machines hosted by hypervisors 108 running on servers 106. VMs 110 can include workloads running on a guest operating system on a respective server. Hypervisors 108 can provide a layer of software, firmware, and/or hardware that creates and runs VMs 110. Hypervisors 108 can allow VMs 110 to share hardware resources on servers 106, and the hardware resources on servers 106 to appear as multiple, separate hardware platforms. Moreover, hypervisors 108 and servers 106 can host one or more VMs 110. For example, server 106_{A} and hypervisor 108_{A} can host VMs 110_{A-B}.

It is understood that servers 102 can be virtual or physical devices (e.g., baremetal servers). Similarly, the servers can be configured to run VMs, and/or other virtual network devices, such as containers, without departing from the scope of the technology.

In some cases, some or all of servers 106, hypervisors 108, and/or VMs 110 can represent one or more tenant spaces. A tenant space can include workloads, services, applications, devices, and/or resources that are associated with one or more clients or subscribers. Accordingly, traffic in network environment 100 can be routed based on specific tenant policies, spaces, agreements, configurations, etc. Moreover, addressing can vary between one or more tenants. In some configurations, tenant spaces can be divided into logical segments and/or networks and separated from logical segments and/or networks associated with other tenants.

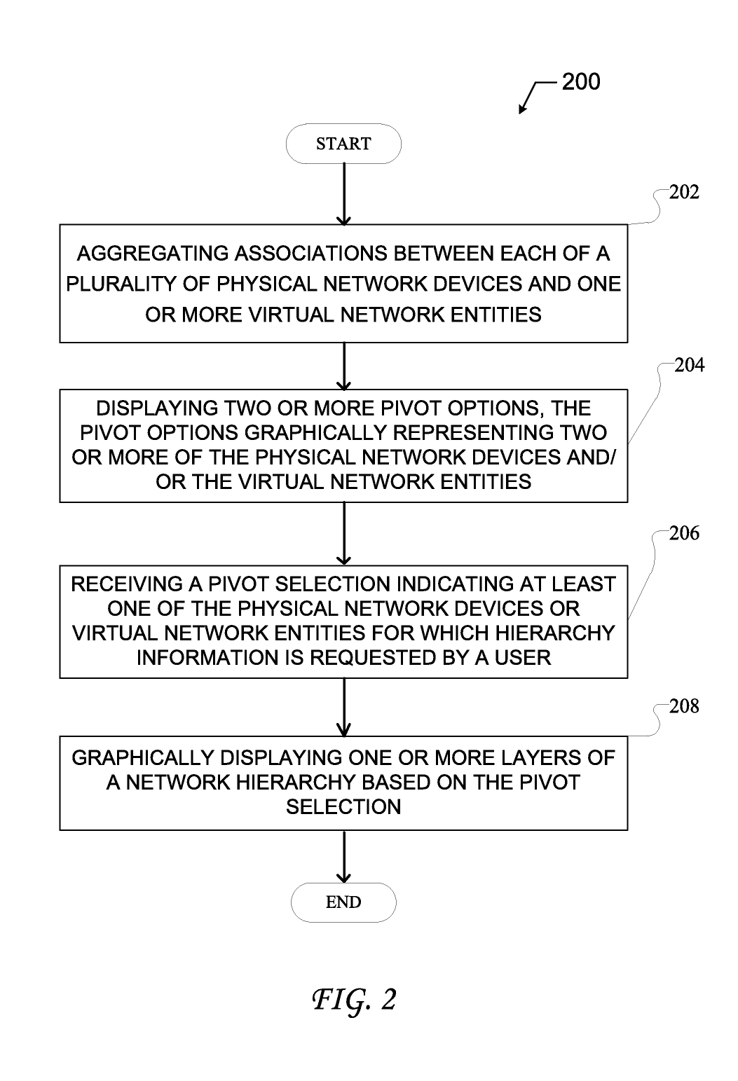

FIG. 2 illustrates steps of an example process 200 for graphically representing layers of a network hierarchy. Process 200 begins with step 202 in which associations between each of a plurality of physical network devices and one or more virtual network entities are aggregated.

In functioning overlay networks, associations between physical devices (underlay infrastructure) and virtual entities (overlay infrastructure) are inherent in the network configuration. However, physical device/virtual entity associations can be aggregated, for example, by a network controller and/or using network management software for the purpose of generating network hierarchy visualizations.

Aggregated associations can represent relationships between any portion of underlay infrastructure (e.g., physical switches, host addresses, and/or server addresses, etc.), and any portion of overlay architecture, e.g., virtual entities, such as routers, subnets, and/or virtual machines, etc. By way of example, aggregated associations can identify relationships between tenants and one or more routers or overlay networks, relationships between virtual machines and one or more host devices, and/or relationships between host devices and one or more subnets, etc.

Subsequently, at step 204, at least one pivot option is graphically displayed, which represents at least one physical network device or virtual network entity. In some aspects, two or more selectable pivot options can be displayed, for example, in a relationship that gives hierarchical context between the displayed options. As used herein, “pivot options” can refer to any user-selectable graphical display (e.g., icon) that represents either a physical or virtual network element. Pivot points can be used to represent network elements for which various hierarchical layers and context can be dynamically provided, for example, in response to user selections.

At step 206, a pivot selection is received, indicating a least one physical network device (or virtual network entity) for which hierarchy information is requested. A pivot selection can be received using virtually any input device type, such as a graphical pointer, or touch based display. By way of example, a pivot option representing a virtual router can be displayed (e.g., to a user via a graphical display device). A pivot selection can then be received from the user, such as, when the user selects (“clicks”) the pivot option with a graphical cursor.

Subsequently, at step 208, one or more layers of a network hierarchy are graphically displayed in response to (or based on) the pivot selection. Depending on the pivot selection, the graphical display can be updated to display a relationship between layers of the network hierarchy and device represented by the pivot option (either virtual or physical). In this manner, the pivot option can be used to represent a selectable vantage point, from which various overlay/underlay portions of network hierarchy may be viewed.

As discussed in further detail below, the graphically displayed portions of network hierarchy can correspond with one or more layers of network underlay infrastructure, for example, providing additional information about physical devices and/or network layers in relation to a device corresponding with the selected pivot point. Alternatively, the graphically displayed portions of network hierarchy can correspond with one or more layers of network overlay infrastructure, for example, providing additional information about virtual devices (e.g., routers, virtual machines, service function chains, etc.), and/or virtual network entities (e.g., virtual networks or subnets), in relation to a device corresponding with the selected pivot point.

In some aspects, graphical displays of context can also be provided, for example, to provide the user with graphical depictions of a location of a selected pivot within various layers of a network hierarchy tree. As discussed in further detail below, context displays can provide physical and/or logical context for the location of the pivot point, for example, to provide additional information with respect to the type of hierarchy information displayed, as well as information identifying particular tenants, etc.

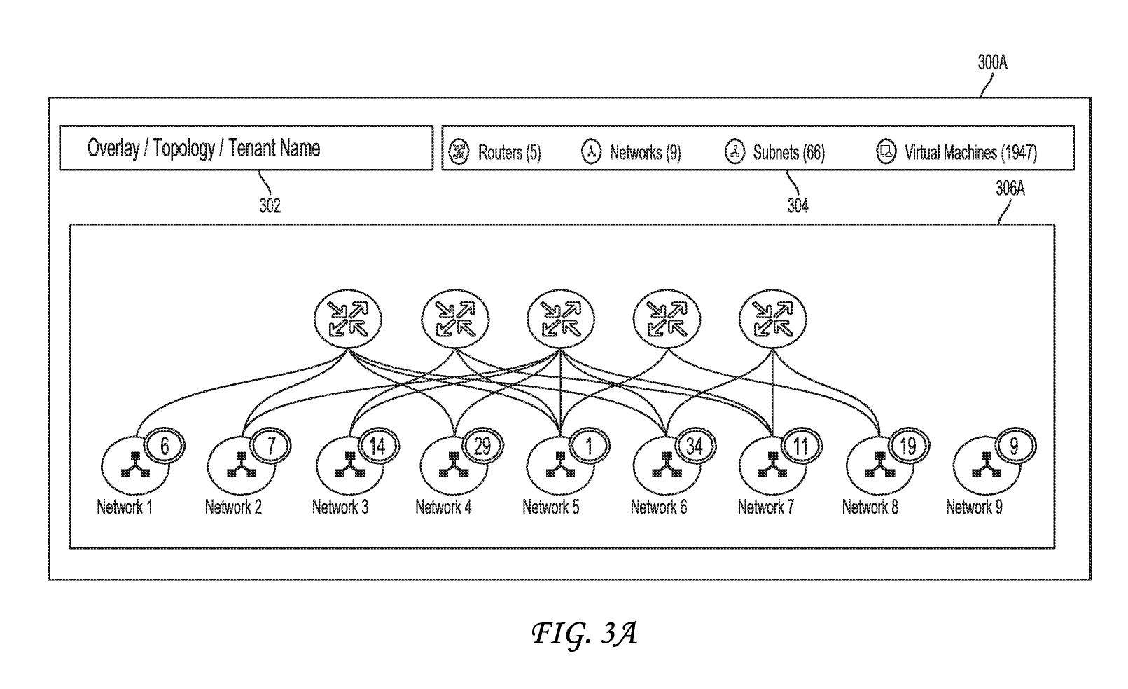

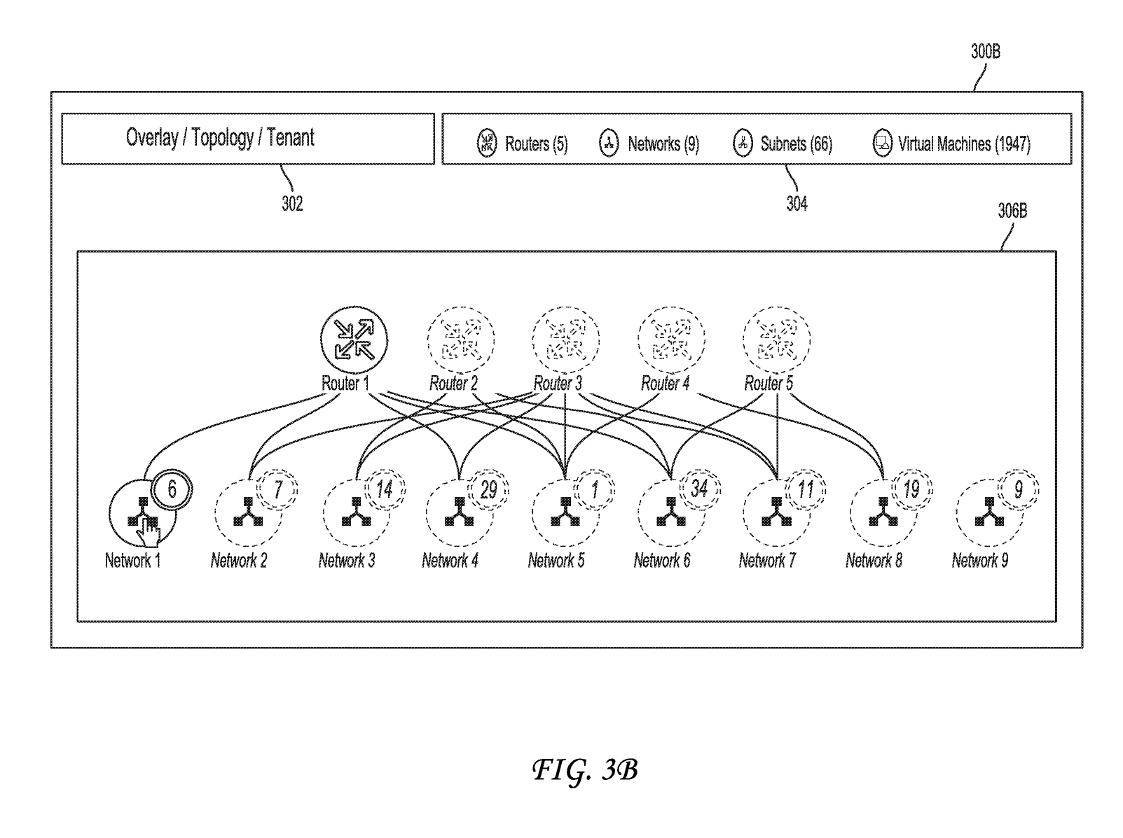

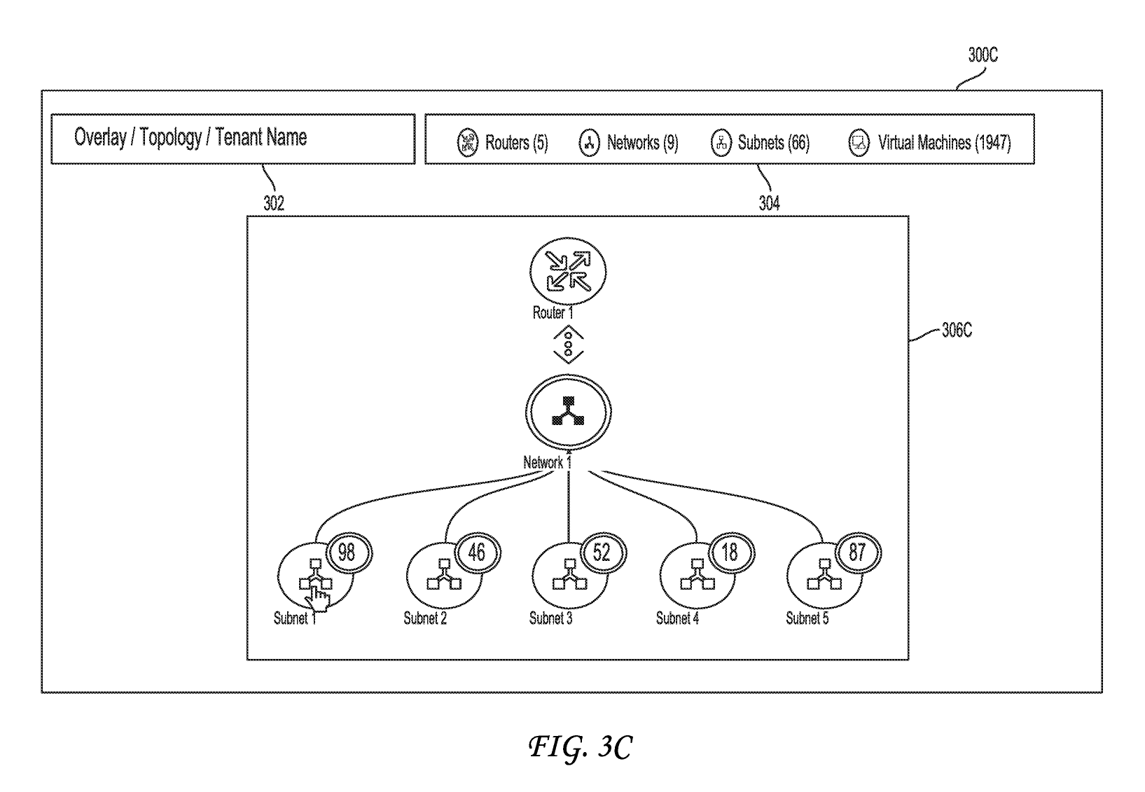

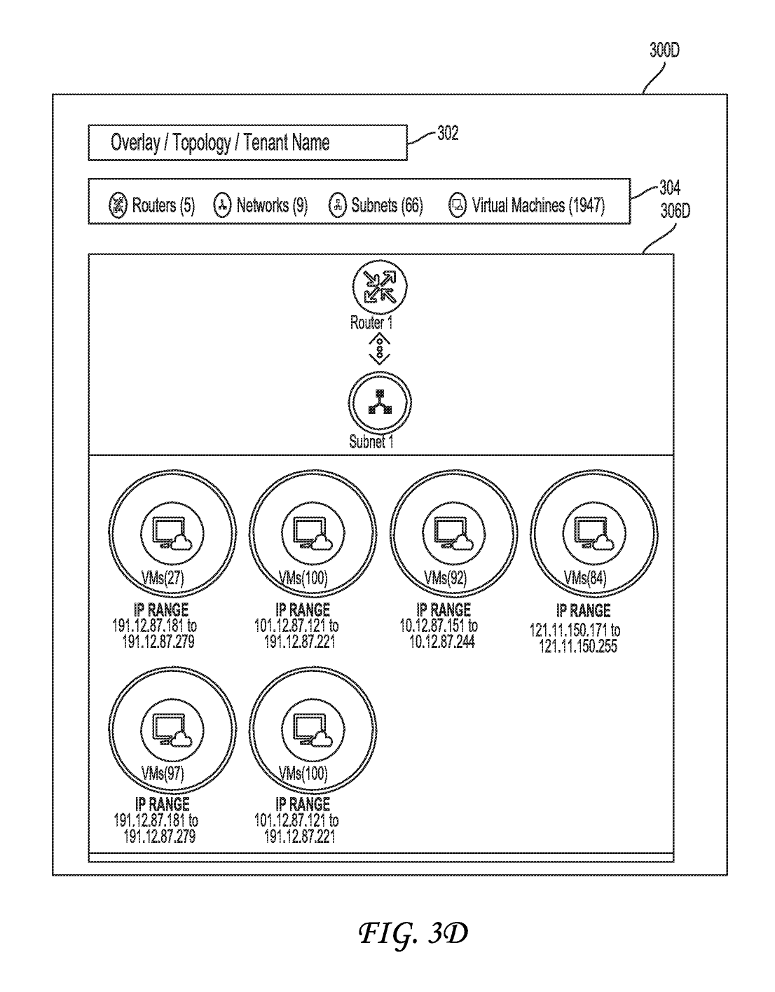

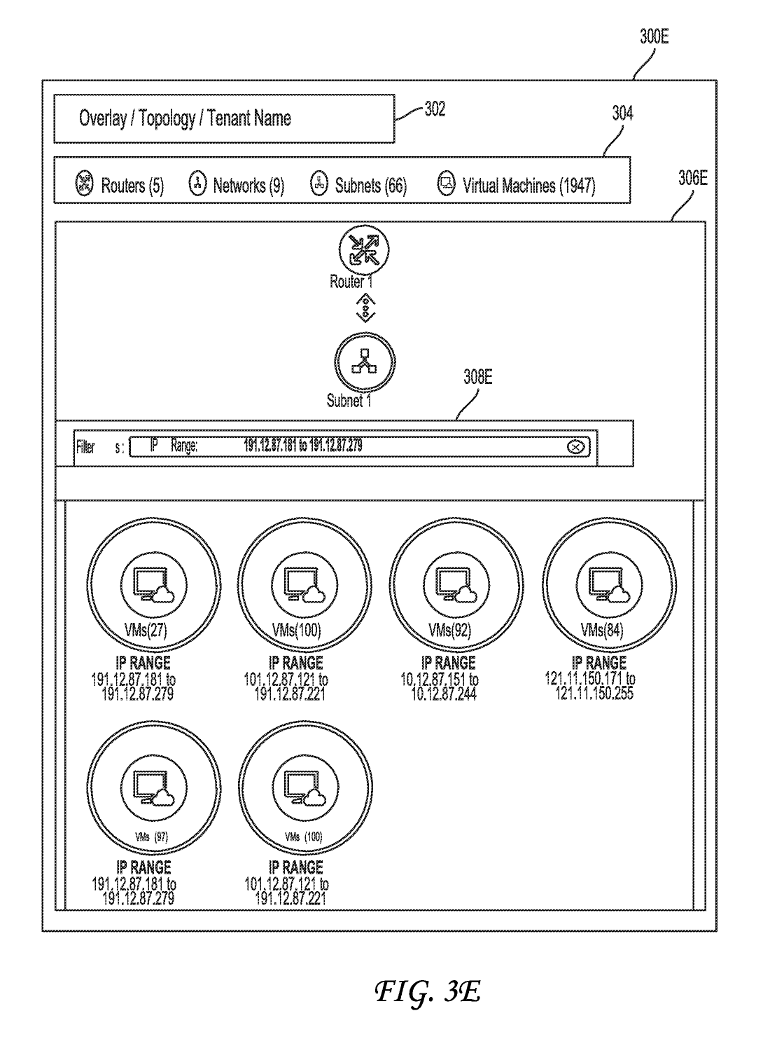

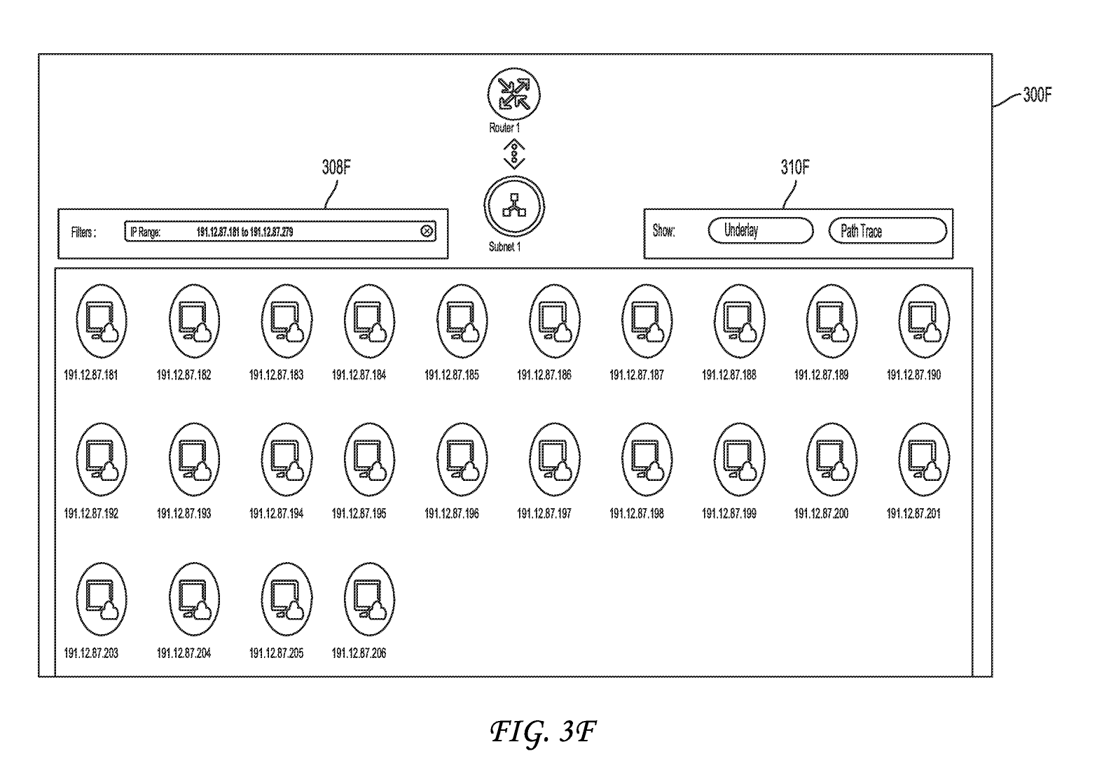

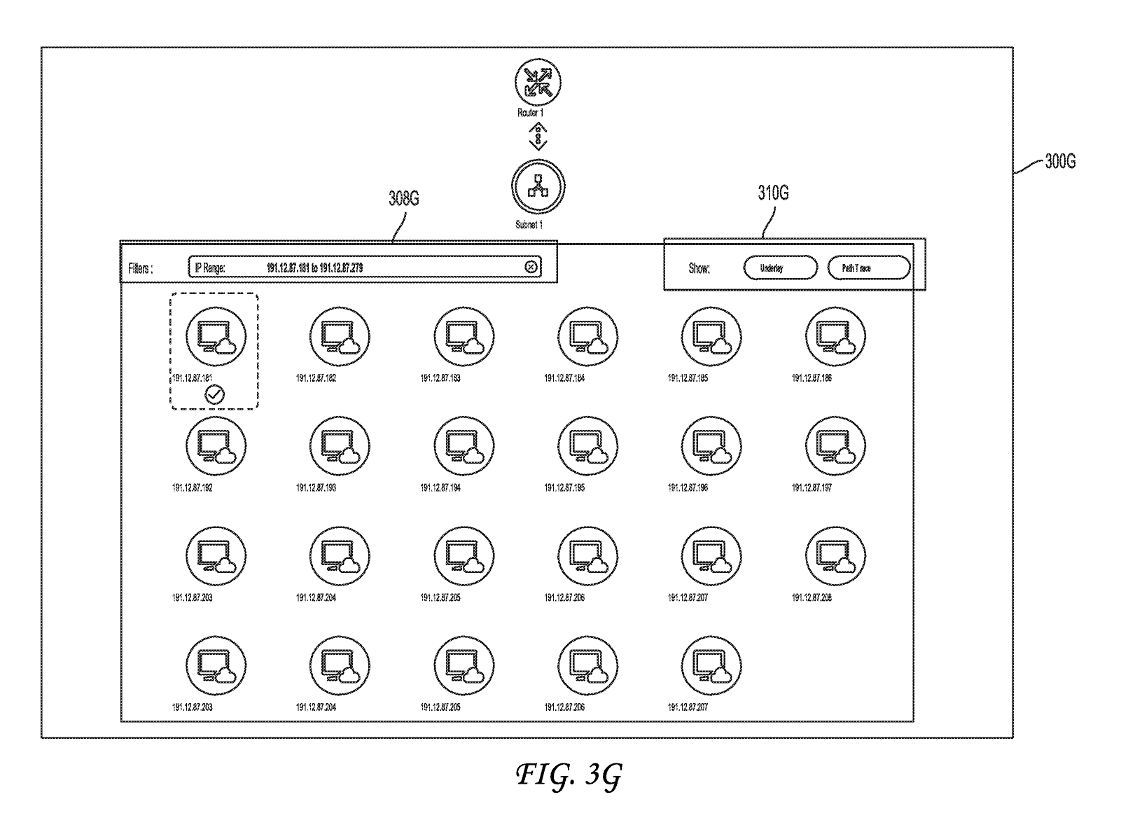

FIGS. 3A-3D illustrate examples of various graphical displays used to visualize layers of a network overlay hierarchy. FIG. 3A includes a graphical display 300A that provides graphical information representing various aspects of one or more underlying tenants and or networks.

In particular, graphical display 300A includes context graphics (302, 304) that provide graphical information regarding the network hierarchies displayed in hierarchy display 306A. For example, context graphic 302 provides an indication of the type of network information displayed (e.g., “Overlay” and “Topology”), as well as information pertaining to an entity associated with the display (e.g., “Tenant Name”). Additional information for resources associated with the indicated tenant is provided by context graphic 304. In the illustrated example, a number of routers, networks, subnets, and virtual machines (VMs) are indicated. However, it is understood that other types of network information can be provided, without departing from the scope of the technology.

Hierarchy display 306A graphically indicates an overlay hierarchy associated with “Tenant Name.” In the illustrated example, five routers provide connection between nine networks associated with the tenant. As also illustrated, each network is associated with a number of subnets that are indicated using an adjacently placed numeric graphic. By way of example, ‘Network 1’ contains ‘6’ subnets, whereas ‘Network 6’ contains ‘34’ subnets. It is understood that any number of routers, networks, and/or subnets can be provided in the overlay hierarchy of display 306A, without departing from the scope of the technology.

As discussed above, any of the displayed network elements in hierarchy display 306A can function as pivot options. That is, any of the graphics associated with the displayed routers and/or networks for ‘Tenant Name’ can be selected as a pivot, around which, additional network hierarchy information is displayed.

FIG. 3B illustrates graphical display 300B that depicts the receipt of a pivot selection. In this example, user selection of a pivot option (i.e., a pivot selection) associated with ‘Network 1’ is received. In response, hierarchy display 306B updates to graphically represent overlay hierarchy information for the selected pivot. That is, hierarchy display 306B provides visual indications of overlay associations pertaining to Network 1, e.g., a relationship to ‘Router 1.’ In turn, other network elements provided by hierarchy display 306B are minimized and/or de-emphasized.

FIG. 3C illustrates graphical display 300C, in which hierarchy display 306C is used to graphically illustrate further overlay hierarchy with respect to the selected pivot (i.e., Network 1). As illustrated in hierarchy display 306C, Network 1 resides under Router 1, and includes multiple subnets, i.e., Subnet 1-Subnet 5. Each subnet associated with Network 1 also includes multiple virtual machines, illustrated using an adjacently placed numeric graphics. By way of example, Subnet 1 is associated with ‘98’ virtual machines, Subnet 2 is associated with ‘46’ virtual machines, Subnet 3 is associated with ‘52’ virtual machines, Subnet 4 is associated with ‘18’ virtual machines, and Subnet 5 is associated with ‘87’ virtual machines.

It is understood that a different number of Subnets and/or virtual machines can be indicated by display 300C, without departing from the technology. Additionally, graphics used to represent any of the displayed network elements (e.g., Router 1, Network 1, Subnet 1-5, and/or any virtual machines) can be different than the example illustrated by FIG. 3C, without departing from the technology.

As also illustrated by graphical display 300C, a user provided pivot selection can indicate an additional pivot option for which network hierarchy information can be displayed. In the illustrated example, Subnet 1 is selected.

FIG. 3D illustrates an example of a graphical display 300D, providing an updated overlay hierarchy following selection of Subnet 1. Graphical display 300D includes hierarchy display 306D depicting a relationship between virtual machines (VMs) and Subnet 1. In the illustrated example, VMs associated with Subnet 1 are provided in context of a respective Internet Protocol (IP) address range.

FIG. 3E illustrates an example of a graphical display 300E, including an applied selection of display options 308E. In the provided example, display options 308E indicate display criteria to be applied to the VMs associated with Subnet 1, i.e., based on an indicated IP address range.

FIG. 3F illustrates an example of a graphical display 300F, after application of an IP display option from the selection of display options 308E. Graphical display 300F also provides additional display options 310F that provide selectable options to display additional infrastructure details based on selectable underlay and path trace parameters. In some aspects, user selection of the display options can cause graphical display of associated underlay infrastructure. In turn, selection of the path trace option can cause graphical depictions of paths through various layers of network infrastructure. It is understood that display options 310F can include different display criteria, without departing from the scope of the technology.

FIG. 3G illustrates an example of a graphical display 300G, after application of underlay display options selected among display options 310F. Graphical display 300G also indicates selection of a virtual machine for which newly selected display options 310G are to be applied.

By way of example, the virtual machine of Subnet 1 associated with IP address 191.12.87.181 is selected. This selection represents a new pivot around which additional graphical depictions of network hierarchy can be displayed. With the selection of the underlay display option, subsequent displays of network hierarchy can be provided in context of underlay (physical) infrastructure.

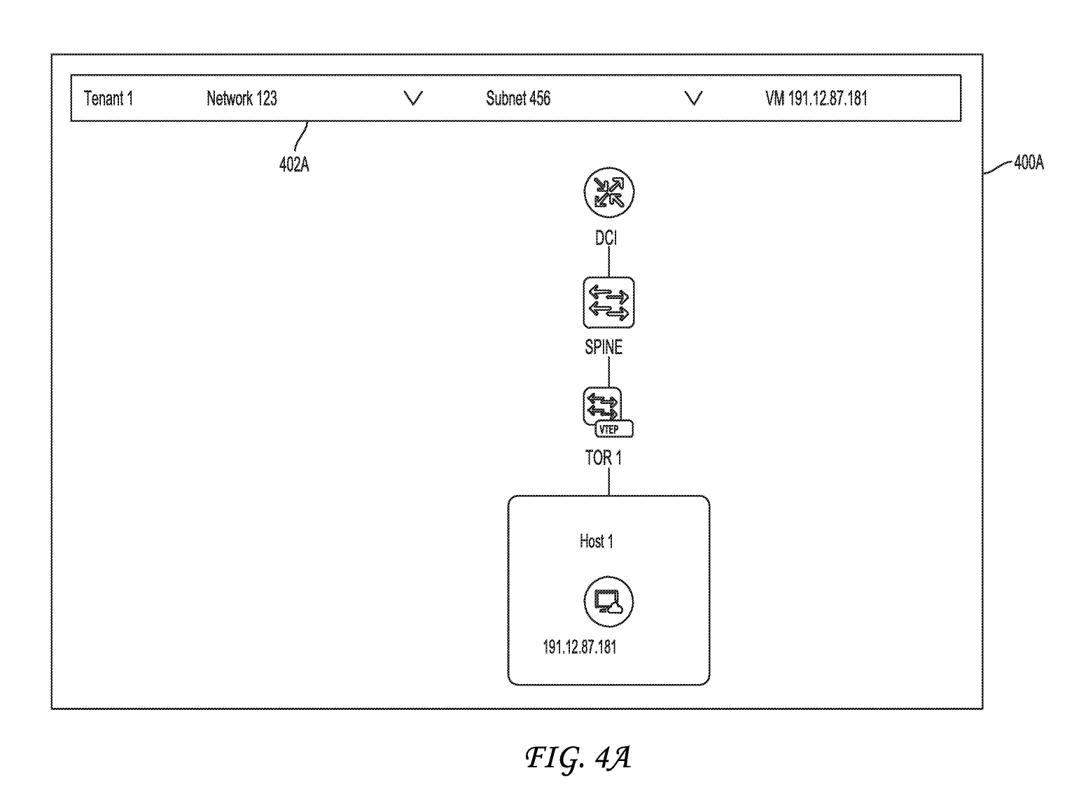

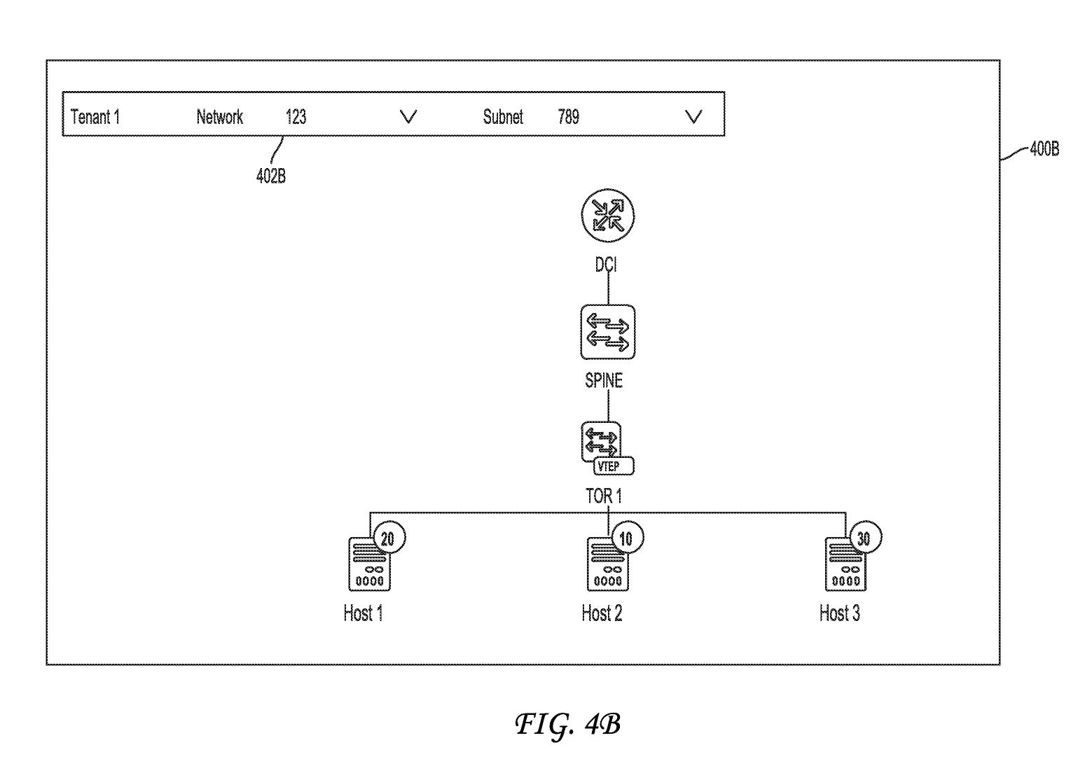

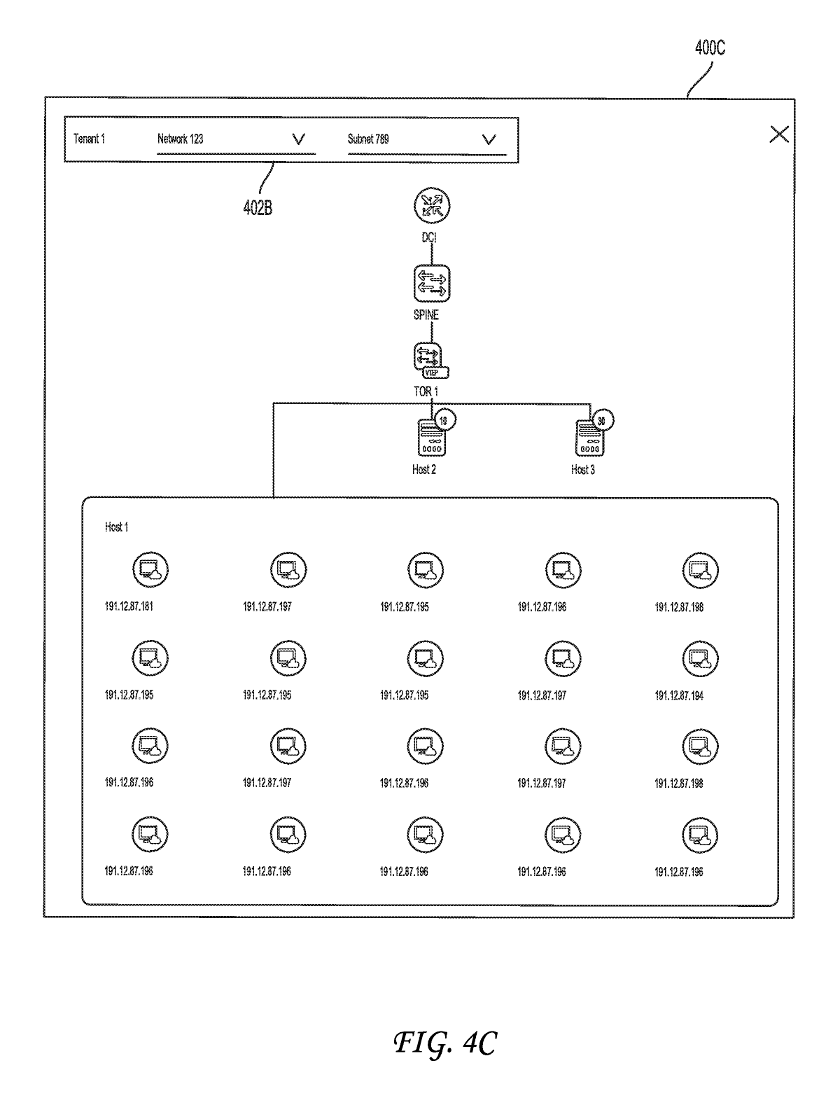

FIG. 4A graphically illustrates an example of a graphical display 400A, depicting a network underlay hierarchy. In the example of FIG. 4A, the VM associated with IP address 191.12.87.181 is the pivot, as such, underlay hierarchy with respect to the selected VM is displayed.

By way of example, the selected VM physically resides on Host 1 that is connected to TOR 1, which is connected to the SPINE. In turn, the SPINE is connected to the Data Center Interconnect (DCI). As illustrated in graphical display 400A, various layers of the corresponding underlay hierarchy are provided in conjunction with context graphic 402A. As discussed above with respect to the overlay hierarchy examples, context graphic 402A provides a graphical context for a location of the selected pivot (here the selected VM) within the network hierarchy. As illustrated, the selected VM belongs to Tenant 1, and resides in Subnet 456, as part of Network 123.

FIG. 4B illustrates an example of a graphical display 400B, depicting a move up the underlay hierarchy depicted in FIG. 4B. Notably, graphical display 402 includes context display 402B, which indicates contextual information for the displayed underlay hierarchy. In this example, a hierarchy of underlay devices associated with Subnet 789 are displayed, for example, including, Host 1, Host 2, and Host 3.

FIG. 4C illustrates an example of a graphical display 400C in which VMs for Host 1 are depicted. In particular, although the context (as provided by context display 402B), remains unchanged, VMs for Host 1 are depicted. In this example, Host 1 is the selected pivot, with concurrent displays of lower level hierarchies of overlay entities (VMs), higher level hierarchies of underlay infrastructure (TOR 1, SPINE, and DCI), and context fully provided.

By facilitating the convenient transition between views based on the selected pivot and context, aspects of the technology provide enhanced methods for generating network visualizations that are enriched through the integration of underlay and overlay hierarchies.

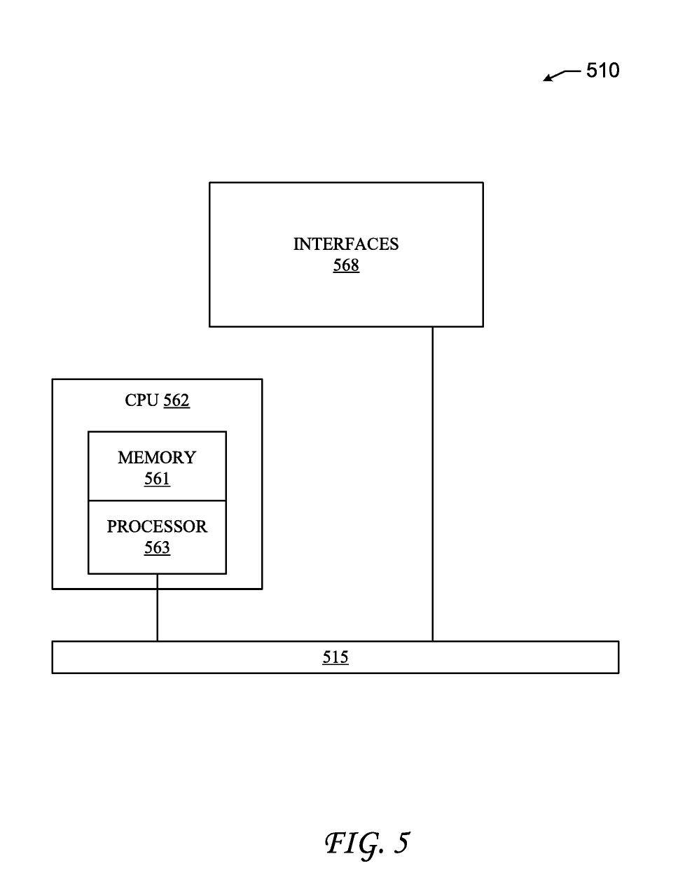

FIG. 5 illustrates an example network device 510 according to some embodiments. Network device can be configured to provide hardware, software, and/or firmware necessary to support the implementation of one or more service function forwarder/s and/or service functions of the technology.

Network device 510 includes a master central processing unit (CPU) 562, interfaces 568, and a bus 515 (e.g., a PCI bus). When acting under the control of appropriate software or firmware, the CPU 562 is responsible for executing packet management, error detection, and/or routing functions. The CPU 562 preferably accomplishes all these functions under the control of software including an operating system and any appropriate applications software. CPU 562 may include one or more processors 563 such as a processor from the Motorola family of microprocessors or the MIPS family of microprocessors. In an alternative embodiment, processor 563 is specially designed hardware for controlling the operations of router 510. In a specific embodiment, a memory 561 (such as non-volatile RAM and/or ROM) also forms part of CPU 562. However, there are many different ways in which memory could be coupled to the system.

Interfaces 568 are typically provided as interface cards (sometimes referred to as “line cards”). Generally, they control the sending and receiving of data packets over the network and sometimes support other peripherals used with the router 510. Among the interfaces that can be provided are Ethernet interfaces, frame relay interfaces, cable interfaces, DSL interfaces, token ring interfaces, and the like. In addition, various very high-speed interfaces can be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 562 to efficiently perform routing computations, network diagnostics, security functions, etc.

Although the system shown in FIG. 5 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 561) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

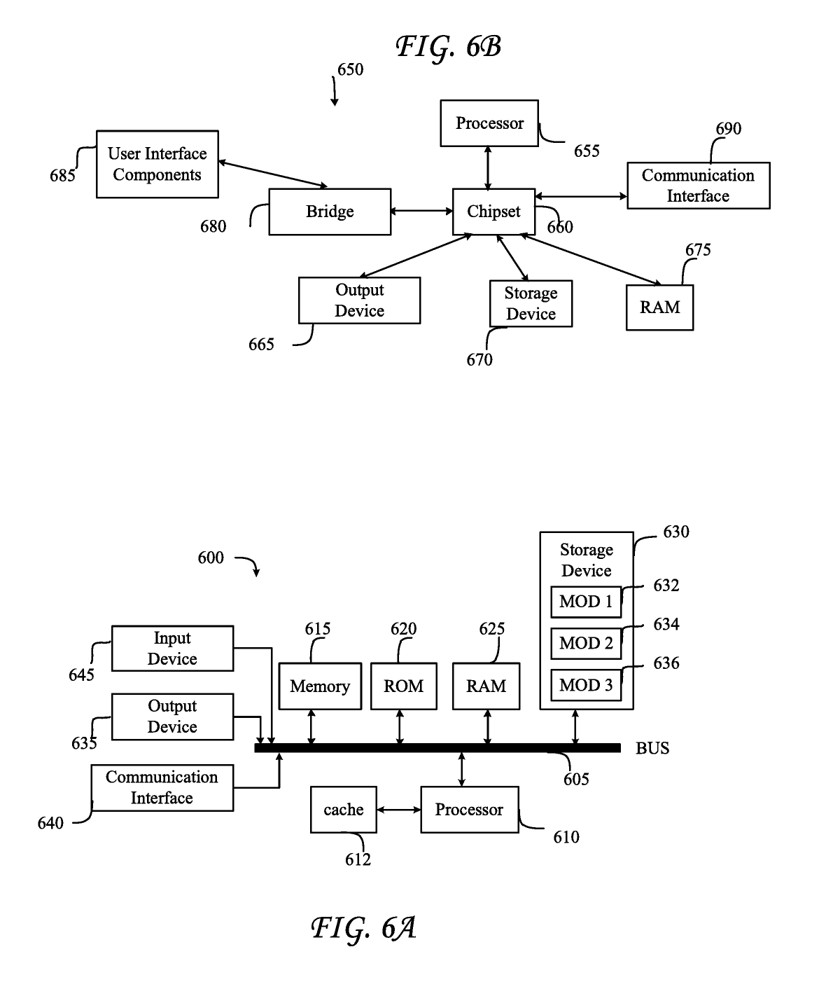

FIG. 6A and FIG. 6B illustrate example system embodiments. The more appropriate embodiment will be apparent to those of skill in the art when practicing the present technology. Persons of ordinary skill in the art will also readily appreciate that other system embodiments are possible.

FIG. 6A illustrates a system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 can be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor can be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates an example computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output device 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that example systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

It should be understood that features or configurations herein with reference to one embodiment or example can be implemented in, or combined with, other embodiments or examples herein. That is, terms such as “embodiment”, “variation”, “aspect”, “example”, “configuration”, “implementation”, “case”, and any other terms which may connote an embodiment, as used herein to describe specific features or configurations, are not intended to limit any of the associated features or configurations to a specific or separate embodiment or embodiments, and should not be interpreted to suggest that such features or configurations cannot be combined with features or configurations described with reference to other embodiments, variations, aspects, examples, configurations, implementations, cases, and so forth. In other words, features described herein with reference to a specific example (e.g., embodiment, variation, aspect, configuration, implementation, case, etc.) can be combined with features described with reference to another example. Precisely, one of ordinary skill in the art will readily recognize that the various embodiments or examples described herein, and their associated features, can be combined with each other.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa. The word “exemplary” is used herein to mean “serving as an example or illustration.” Any aspect or design described herein as “exemplary” is not necessarily to be construed as preferred or advantageous over other aspects or designs.

Moreover, claim language reciting “at least one of” a set indicates that one member of the set or multiple members of the set satisfy the claim. For example, claim language reciting “at least one of A, B, and C” or “at least one of A, B, or C” means A alone, B alone, C alone, A and B together, A and C together, B and C together, or A, B and C together.

1. A computer-implemented method for mapping hierarchical relationships of a network topology, comprising:
aggregating associations between each of a plurality of physical network devices and one or more virtual network entities;
displaying two or more pivot options, the pivot options graphically representing two or more of the physical network devices or the virtual network entities;
receiving a pivot selection indicating at least one of the physical network devices or the virtual network entities for which hierarchy information is requested by a user; and
graphically displaying one or more layers of a network hierarchy based on the pivot selection.

2. The computer-implemented method of claim 1, wherein graphically displaying the one or more layers further comprises:
graphically displaying a relationship between the one or more layers of the network hierarchy and the physical network devices or the virtual network entities.

3. The computer-implemented method of claim 1, wherein at least one of the one or more layers of the network hierarchy corresponds with a network underlay.

4. The computer-implemented method of claim 1, wherein at least one of the one or more layers of the network hierarchy corresponds with a network overlay.

5. The computer-implemented method of claim 1, wherein graphically displaying one or more layers of a network hierarchy based on the pivot selection, further comprises:
concurrently displaying a network context associated with the pivot selection, the network context graphically depicting a location of the pivot selection in a hierarchy tree.

6. The computer-implemented method of claim 1, wherein the physical network devices comprise one or more of: a switch, a router, a server, and a data center.

7. The computer-implemented method of claim 1, wherein the virtual network entities comprise one or more of: a virtual machine (VM), or a subnet.

8. A system comprising:
at least one processor;
a network interface coupled to the at least one processor; and
a memory device storing instructions that, when executed by the at least one processor, cause the at least one processor to perform operations comprising:
aggregating associations between each of a plurality of physical network devices and one or more virtual network entities;
displaying two or more pivot options, the pivot options graphically representing two or more of the physical network devices or the virtual network entities;
receiving a pivot selection, the pivot selection indicating at least one of the physical network devices or the virtual network entities for which hierarchy information is requested by a user; and
graphically displaying one or more layers of a network hierarchy based on the pivot selection.

9. The system of claim 8, wherein graphically displaying the one or more layers further comprises:
graphically displaying a relationship between the one or more layers of the network hierarchy and the physical network devices or the virtual network entities.

10. The system of claim 8, wherein at least one of the one or more layers of the network hierarchy corresponds with a network underlay.

11. The system of claim 8, wherein at least one of the one or more layers of the network hierarchy corresponds with a network overlay.

12. The system of claim 8, wherein graphically displaying one or more layers of a network hierarchy based on the pivot selection, further comprises:
concurrently displaying a network context associated with the pivot selection, the network context graphically depicting a location of the pivot selection in a hierarchy tree.

13. The system of claim 8, wherein the physical network devices comprise one or more of: a switch, a router, a server, and a data center.

14. The system of claim 8, wherein the virtual network entities comprise one or more of: a virtual machine (VM), or a subnet.

15. A non-transitory computer-readable storage medium comprising instructions stored therein, which when executed by one or more processors, cause the processors to perform operations comprising:
aggregating associations between each of a plurality of physical network devices and one or more virtual network entities;
displaying two or more pivot options, the pivot options graphically representing two or more of the physical network devices or the virtual network entities;
receiving a pivot selection, the pivot selection indicating at least one of the physical network devices or the virtual network entities for which hierarchy information is requested by a user; and
graphically displaying one or more layers of a network hierarchy based on the pivot selection.

16. The non-transitory computer-readable storage medium of claim 15, wherein graphically displaying the one or more layers further comprises:
graphically displaying a relationship between the one or more layers of the network hierarchy and the physical network devices or the virtual network entities.

17. The non-transitory computer-readable storage medium of claim 15, wherein at least one of the one or more layers of the network hierarchy corresponds with a network underlay.

18. The non-transitory computer-readable storage medium of claim 15, wherein at least one of the one or more layers of the network hierarchy corresponds with a network overlay.

19. The non-transitory computer-readable storage medium of claim 15, wherein graphically displaying one or more layers of a network hierarchy based on the pivot selection, further comprises:
concurrently displaying a network context associated with the pivot selection, the network context graphically depicting a location of the pivot selection in a hierarchy tree.

20. The non-transitory computer-readable storage medium of claim 15, wherein the physical network devices comprise one or more of: a switch, a router, a server, and a data center.
